(19) United States
(12) Patent Application Publication
(10) Pub. No.: US 2026/0350608 A1
(43) Pub. Date: Nov. 5, 2026

(54) SECURE INTER-AGENT AUTHENTICATION AND TRANSACTION SYSTEM

(71) Applicant: Salesforce, Inc., San Francisco, CA (US)

(72) Inventors: Swaroop Jayanthi, Hyderabad (IN); Jose LEJIN P J, Bengaluru (IN); Ratheesh Krishna Vadhyar, Bengaluru (IN)

(73) Assignee: Salesforce, Inc., San Francisco, CA (US)

(21) Appl. No.: 19/196,638

(22) Filed: May 1, 2025

(51) Int. Cl. G06Q 20/40; G06Q 20/38

(52) U.S. Cl. CPC G06Q 20/401; G06Q 20/382

(57) ABSTRACT

In some embodiments, a first agent receives a request for a transaction where the request is from a second agent. The method authenticates the second agent using an authentication policy to determine an authentication result. The authentication policy is based on an identity of the second agent. Chained transaction metadata is determined based on multiple transactions including the second agent and a third agent. The method validates the transaction using the chained transaction metadata based on a transaction policy to determine a transaction validation result. It is determined whether to validate the transaction based on the authentication result and the transaction validation result.

### COPYRIGHT NOTICE

A portion of the disclosure of this patent document contains material which is subject to copyright protection. The copyright owner has no objection to the facsimile reproduction by anyone of the patent document or the patent disclosure as it appears in the United States Patent and Trademark Office patent file or records but otherwise reserves all copyright rights whatsoever

### FIELD OF TECHNOLOGY

This patent document relates generally to network security and more specifically to validation of artificial intelligence agents.

### BACKGROUND

In today's digital landscape, inter-agent communication and transactions have become increasingly complex, with multiple agents interacting across various networks and systems. This complexity has introduced significant security risks, as malicious or rogue agents can compromise sensitive data and disrupt critical operations.

The traditional approach to securing inter-agent interactions relies heavily on certificate-based authentication, which often falls short in addressing sophisticated threats. These methods fail to provide granular control over agent activities, allowing unauthorized access to sensitive information and creating vulnerabilities that can be exploited by malicious agents.

The state of the art in inter-agent authentication and authorization is characterized by limited scalability, inadequate threat detection, and insufficient adaptability to evolving security threats. Current solutions often rely on static policies, manual updates, and rudimentary analytics, which are no match for the dynamic and increasingly sophisticated nature of modern cyber threats. As a result, organizations face significant challenges in ensuring the integrity and confidentiality of their data.

### BRIEF DESCRIPTION OF THE DRAWINGS

The included drawings are for illustrative purposes and serve only to provide examples of possible structures and operations for the disclosed inventive systems, apparatus, methods and computer program products for network security. These drawings in no way limit any changes in form and detail that may be made by one skilled in the art without departing from the spirit and scope of the disclosed implementations.

FIG. 1 depicts a system for validating transactions according to some embodiments.

FIG. 2 depicts different transactions that can be performed according to some embodiments.

FIG. 3 depicts a more detailed example of an agent authentication system and a transaction validation system of an agent according to some embodiments.

FIG. 4 depicts a flowchart of a method for processing transactions according to some embodiments.

FIG. 5 depicts a flowchart for generating chained metadata according to some embodiments.

FIG. 6 depicts a flowchart of a method for validating a transaction according to some embodiments.

FIG. 7 shows a block diagram of an example of an environment that includes an on-demand database service configured in accordance with some implementations.

FIG. 8A shows a system diagram of an example of architectural components of an on-demand database service environment, configured in accordance with some implementations.

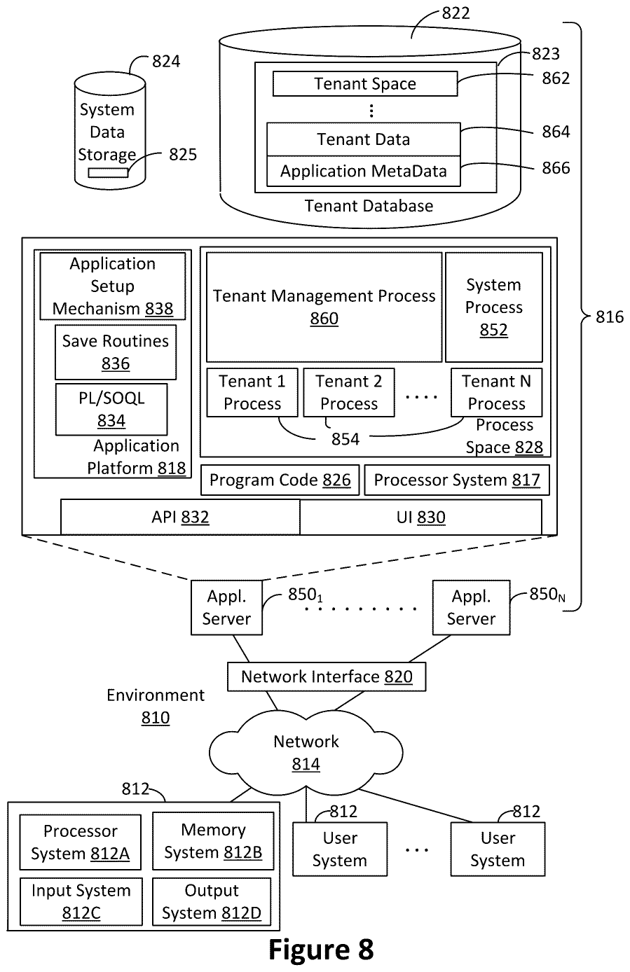

FIG. 8B shows a system diagram further illustrating an example of architectural components of an on-demand database service environment, in accordance with some implementations.

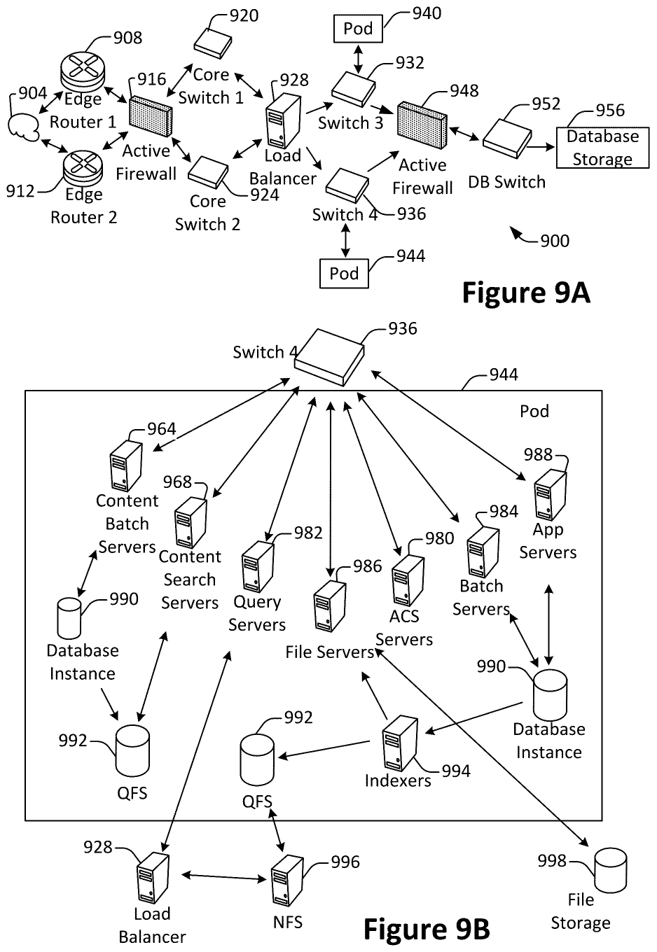

FIG. 9 illustrates one example of a computing device.

### DETAILED DESCRIPTION

### System Overview

A system validates transactions for inter-agent transactions. The validation may include authentication of agents and also transaction validation. An agent refers to an entity that automatically performs a specific set of tasks or functions within a system or environment. In some embodiments, the agents are artificial intelligence (AI) agents that are trained to perform the set of tasks. The system may include an agent authentication system and a policy-based transaction validation system. The agent authentication system may include a dual-layer authentication mechanism that combines cryptographic (e.g., certificate-based) validation with artificial intelligence (AI)-driven identity verification to authenticate agents. The transaction validation system uses policies that define transaction-specific authorizations, providing granular control over agent activities and avoiding blanket permissions. The transaction validation may include analyzing chained metadata from multiple transactions with multiple agents.

A transaction flow may involve inter-agent communications that occur in a multiple hops via a series of chained transactions of multiple agents. For instance, when a customer places an order on the platform, it triggers Agent A, the order manager, to initiate a transaction with Agent B, the inventory checker, to verify if the product is in stock. Upon confirmation of availability, Agent B then initiates a new transaction with Agent C, the payment processor, to handle the payment transaction. Subsequently, Agent C processes the payment and verifies its success, before initiating another transaction with Agent D, the shipping coordinator, to arrange for shipping and logistics.

This series of chained transactions enables the system to efficiently process complex orders while ensuring that each step is authorized and authenticated. The chain of transactions unfolds as follows: Agent A (Order Manager) initiates a transaction with Agent B (Inventory Checker), who then initiates a transaction with Agent C (Payment Processor), and finally, Agent C initiates a transaction with Agent D (Shipping Coordinator). Each agent completes its task and then passes on the necessary information to the next agent in the chain, allowing the order to be processed seamlessly. The system ensures that each agent is authenticated and authorized to perform its specific task, validating transactions between agents, and embedding metadata for each specific agent into the transaction to facilitate chained transaction analysis and security checks.

In another example, for a stock market customer, agents are deployed with specific roles. Agent 1 handles account management, while Agent 2 tracks the portfolio. When a customer requests to sell shares of a company, it is crucial that only authorized agents handle such requests. However, Agent 2, who is not authorized for this task, processes the requests. This leads to potential security risks and also leads to compliance issues.

By securing these inter-agent communications, the system can protect sensitive customer data, prevent unauthorized access, and maintain a trusted environment for processing transactions. The system's ability to authenticate and authorize agents, validate transactions, and analyze metadata enables it to detect potential security threats and prevent them from compromising the system. The authentication of agents using AI-driven policies is significantly more than certificate-based authentication. The AI-driven authentication may be needed because the behavior of agents may need to be authenticated, not just the certificates. Also, the validation of transactions is significantly more than the certificate-based authentication. The inter-agent communications in the chain of transactions should be analyzed. The insertion of chained metadata in a stack improves the transaction analysis to allow agents to validate transactions.

### System

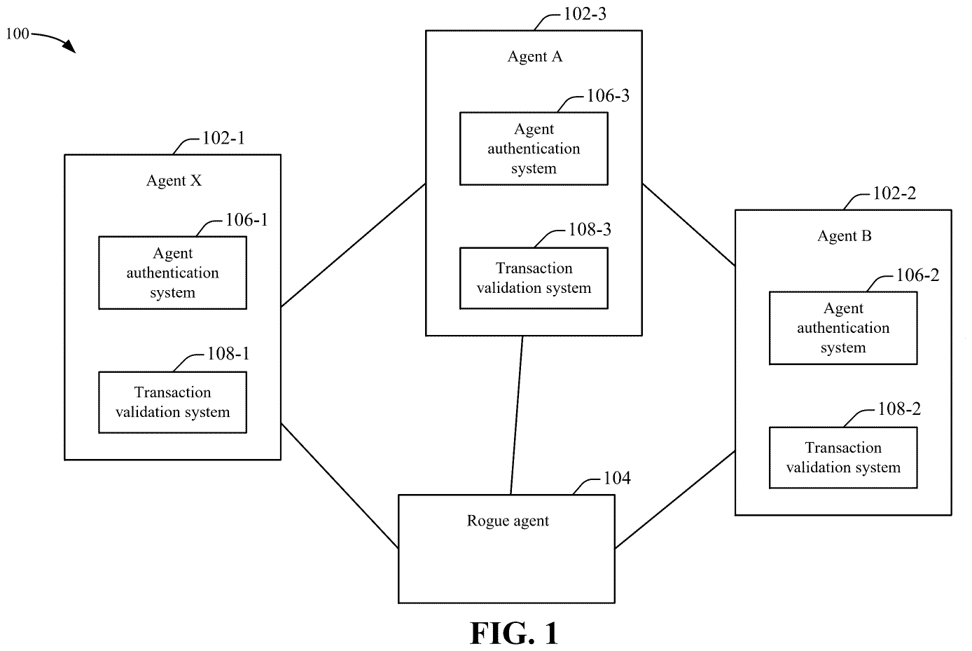

FIG. 1 depicts a system 100 for validating transactions according to some embodiments. System 100 includes multiple agents include an Agent B 102-2, an Agent A 102-3, an Agent X 102-1, and a rogue agent 104. Agents A, B, and X may be authorized agents on a network of system 100 and rogue agent 104 may not be an authorized agent. The agents may participate in transactions in system 100, some of which may be multi-hop transactions via multiple agents (e.g., three or more agents) although point to point transactions between two agents may also be validated.

Authentication, authorization, and validation may be described interchangeably. In general, the terms may indicate the verification of information. In some embodiment, authentication refers to the process of verifying the identity of an agent 102. Authorization may include verifying whether agent 102 has permission to perform the action of the transaction. Validation may include verifying the information for the transaction.

Agents 102 may include an agent authentication system 106 (e.g., 106-1, 106-2, and 106-3) and a transaction validation system 108 (e.g., 108-1, 108-2, and 108-3). Although these systems are shown in agents 102, agent authentication system 106 and transaction validation system 108 may be located externally from agents 102, such as in a centralized server. Agent authentication system 106 may authenticate an identity of a respective agent for a transaction. For example, the authentication may use cryptography, such as certificate based and signature based authentication. Additionally, artificial intelligence (AI) identity authentication may also be performed using AI policies.

Transaction validation system 108 may validate the transaction to determine whether the agent can perform the transaction. The validation may use chained metadata for inter-agent communication to validate the transaction. The chained metadata may include information inserted by the original agent and intermediary agents in the transaction. Validation system 108 uses the chained metadata to validate information for the transactions by the original agent and intermediary agents in the chain. This ensures that every agent involve in a transaction chain complies with defined policies and addresses a scenario where a chain of intermediary agents or the source agent may pose security risks.

Rogue agent 104 may be an unauthorized agent. For example, the rogue agent should not be authenticated by system 100 and also a transaction that involves rogue agent 104 should not be validated.

Entities in system 100 may communicate to perform transactions. The transactions may include multiple hops. For example, agent A may process a transaction, and communicate with agent B. Agent B may then communicate with agent X to complete the transaction. Also, the transaction may be point to point. For example, agent B may communicate with agent X to perform the transaction. Rogue agent 104 may also communicate with any of the other agents 102 to attempt to perform transactions in system 100. The transactions may be performed automatically by agents in response to a request. After an original agent receives a request, the agent and other agents may automatically communicate to process the request without interaction with the entity that sent the request. This makes authentication of the chain of transactions important as the entity may not know which agents process a transaction.

The following will describe different transactions.

### Transactions

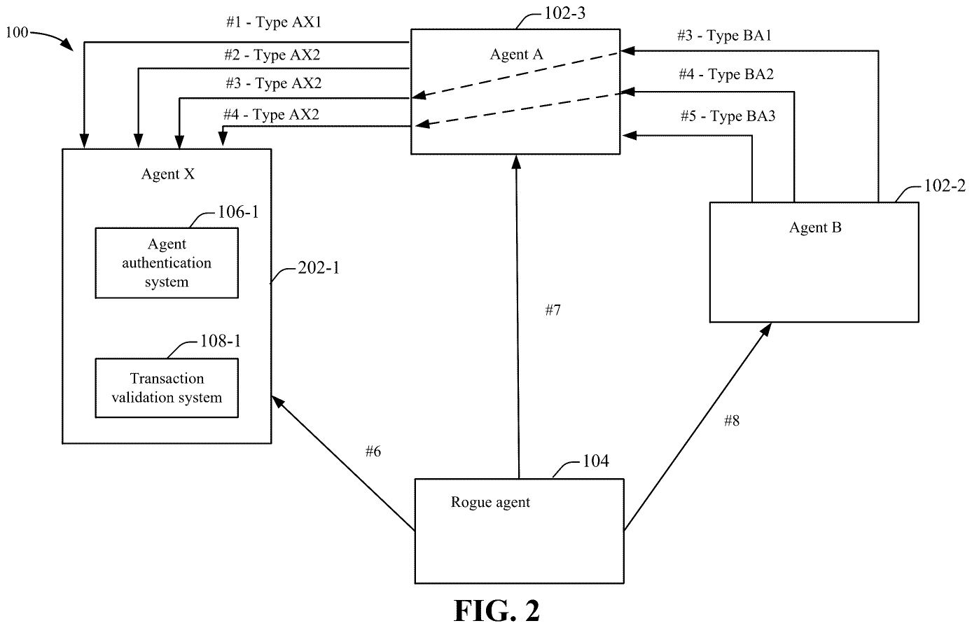

FIG. 2 depicts different transactions that can be performed according to some embodiments. FIG. 2 depicts eight different transactions, but other transactions may be appreciated. A transaction #1 involves Agent A initiating a transaction of type AX1 with Agent X. However, the policy for transaction validation system 108-1 on Agent X explicitly disallows AX1 transactions, resulting in an immediate denial of the request. The transaction validation examines the transaction type (AX1) and then denies the request as per the policy. As a result, the transaction is rejected, and Agent A is notified that the transaction cannot be completed.

In transaction #2, Agent A initiates a transaction of type AX2 with Agent X. Unlike the previous instance, the policy on Agent X allows AX2 transactions, and therefore the request is permitted to proceed. Agent X uses transaction validation security checks to determine that a policy allows AX2 transactions, and the transaction is allowed to complete without any issues. This demonstrates that the system can distinguish between allowed and disallowed transactions based on the policies defined for each agent.

Transaction #3 involves a more complex scenario where Agent B initiates a BA1 transaction with Agent A, which is allowed according to the policy of Agent A. However, Agent A then triggers an AX2 transaction with Agent X as a result of the initial transaction. The chained metadata analysis performed by transaction validation system 108-1 of Agent X identifies the chain of transactions (BA1→AX2) and checks it against the policy. According to a policy, this chain is disallowed on Agent X, resulting in the denial of the AX2 transaction. For example, while the policy may allow AX2 transactions from Agent A to Agent X, the BA1 transaction may not be allowed from Agent B. In another example, the policy on agent A may allow BA1 transactions, but a policy on Agent X may not allow BA1→AX2 transactions. In some cases, the policy on agent X may allow AX2 transactions from Agent A to Agent X individually if not chained with the BA1 transaction from Agent B. The chained metadata may include information for the BA1 transaction, which is used to deny the transaction. This highlights the importance of considering the entire chain of transactions when enforcing security policies.

In transaction #4, Agent B initiates a BA2 transaction with Agent A, which is allowed according to the policy of Agent A. As a result of this initial transaction, Agent A triggers an AX2 transaction with Agent X. The chained metadata analysis performed by transaction validation system 108-1 of Agent X identifies the chain of transactions (BA2→AX2) and checks it against the policy. In this case, this chain complies with the policy on Agent X, and the AX2 transaction is permitted to complete without any issues. Here, a chain of BA2→AX2 is allowed as opposed to a chain of BA1→AX2. This demonstrates that the system can correctly identify allowed chains of transactions and permit them to proceed.

A transaction #5 involves Agent B initiating a transaction of type BA3 with Agent A. However, the policy on Agent A explicitly disallows BA3 transactions, resulting in an immediate denial of the request. The transaction validation examines the transaction type, and the policy check reveals that BA3 transactions are not permitted. As a result, the transaction is rejected, and Agent B is notified that the transaction cannot be completed.

Transactions #6, #7, and #8 are initiated by rogue agent 204 attempting to exploit vulnerabilities in the system. However, agents detect these attempts during the authentication stage and deny the transactions immediately. In this case, transaction validation system 108 may not be run. The authentication process involves verifying the identity of the agent initiating the transaction, and since these agents are identified as rogue, their transactions are rejected outright. Additionally, even if the rogue agent 104 is able to be authenticated using a certificate, the AI-driven policy may detect abnormal behavior and not authenticate the rogue agent. Also, the transaction may be denied because the rogue agent is performing transactions that are outside of a permitted role. This highlights the effectiveness of the system's security protocols in preventing unauthorized access and protecting against potential threats.

The above described the general processes of transactions. The following describes agent authentication system 106 and transaction validation system 108 in more detail.

### Agent Authentication System and Transaction Validation System

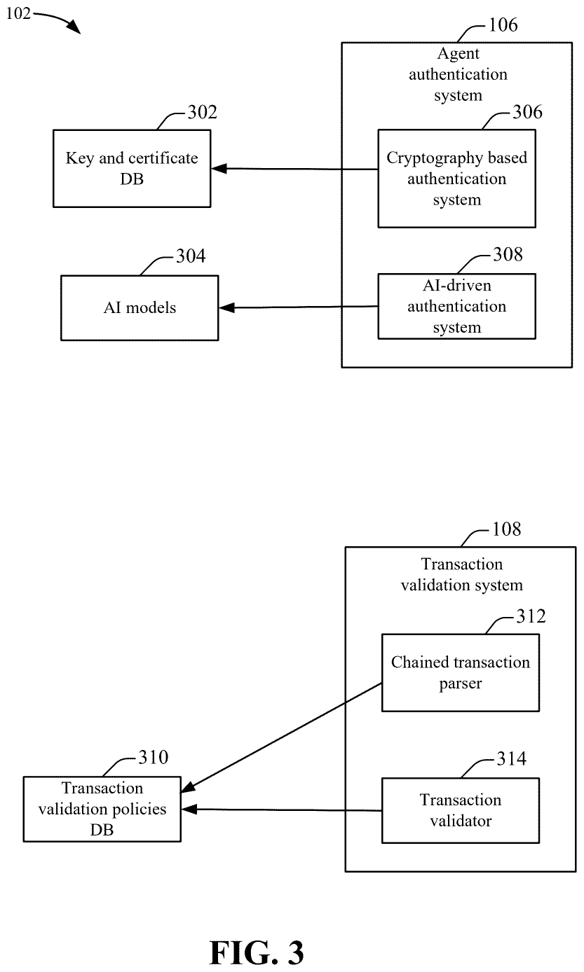

FIG. 3 depicts a more detailed example of agent authentication system 106 and transaction validation system 108 of an agent 102 according to some embodiments. Agent authentication system 106 includes a cryptography based authentication system 306 and an AI-driven authentication system 308. The authentication process is a multi-layered approach that combines cryptography (e.g., certificate validation and digital signature verification) in cryptography based authentication system 306 with advanced AI-driven background identity verification in AI-driven authentication system 308. Initially, cryptography based authentication system 306 authenticates the identity of agents 102 through a layer of certificate validation and digital signature verification, ensuring that they possess valid credentials and have not been tampered with. Cryptography based authentication system 306 may communicate with key and certificate database (DB) 302 to authenticate the certificates, keys, and other authentication information for a transaction. The authentication may be based on public or private key cryptography.

To further enhance security and address sophisticated threats, AI-driven authentication system 308 incorporates AI-driven background identity verification. AI-driven authentication system 308 leverages machine learning algorithms to monitor historical transaction patterns and behavioral data of agents 102, allowing it to identify potential anomalies indicative of rogue agent activity. By analyzing vast amounts of data, the AI models 304 can detect subtle deviations from normal behavior that may indicate malicious intentions. AI-driven authentication system 308 applies AI models 304 to detect anomalies in real-time, enabling prompt action to be taken against suspected rogue agents 104. Moreover, AI-driven authentication system 308 continuously updates the AI models 304 to adapt to evolving threat patterns, ensuring that they remain effective in detecting and mitigating emerging threats. In some embodiments, AI-driven authentication system 308 inputs characteristics of the transaction into AI models 304, and AI models 304 output an authentication result.

AI-driven authentication system 308 may use historical transaction pattern analysis. AI-driven authentication system 308 analyzes historical transaction data to identify normal behavior patterns for each agent 102, enabling it to detect anomalies that may indicate rogue activity. Also, AI-driven authentication system 308 uses behavioral data monitoring. AI-driven authentication system 308 monitors real-time behavioral data from agents 102, such as login attempts, transaction requests, and other interactions, to identify potential security threats. AI-driven authentication system 308 uses machine learning-based anomaly detection. AI-driven authentication system 308 applies machine learning algorithms to detect anomalies in agent behavior, enabling prompt action to be taken against suspected rogue agents. Also, AI-driven authentication system 308 continuously updates the AI models to adapt to evolving threat patterns, ensuring that they remain effective in detecting and mitigating emerging threats. For example, AI models may be trained based on policies that are defined to characterize valid behavior of agents. For example, policies to detect repeated/iterated logic retry mechanisms from agents that may be symptoms of rogue agents trying to breaking into the network may be defined. The behavior detection is different from authentication because the behavior may have more nuance and the AI models are used to detect the behavior.

Transaction validation system 108 includes a chained transaction parser 312 and a transaction validator 314. Chained transaction parser 312 analyzes the transaction chain and extracts chained metadata, which includes relevant information about the agents involved, their roles, privileges, and trust levels. Chained transaction parser 312 uses this information to categorize agents 102 and determine the applicable policies and authorization rules for each agent 102. Chained transaction parser 312 performs agent categorization to categorize agents 102 based on their roles, privileges, and trust levels, using predefined policies. Policies are defined to categorize agents based on their roles, privileges, and trust levels. For example, agents accessing sensitive financial data are categorized differently from those accessing general customer support information. Policies specify allowable transaction types for each agent category. Authorization decisions are made dynamically at the transaction level, ensuring that agents are only permitted to perform specific tasks as per their assigned policies. Blanket authorizations are explicitly avoided to minimize security risks.

Also, chained transaction parser 312 performs transaction type identification to identify the type of transaction being requested, such as access to sensitive financial data or general customer support information. Then, chained transaction parser 312 performs policy retrieval from transaction validation policies database 310. Chained transaction parser 312 retrieves the applicable policies for each agent category, including the allowable transaction types. Chained transaction parser 312 performs chain analysis to analyze the transaction chain to identify all agents involved and their respective roles, privileges, and trust levels. All the agents and transaction types may be applied to the applicable policies to determine whether the transaction is validated.

Transaction validator 314 may then use the information from chained transaction parser 312 to determine whether the transaction is validated. Transaction validator 314 makes validation decisions based on the parsed transaction information and the applicable policies. Transaction validator 314 makes an authorization decision for each agent 102 in the transaction chain, ensuring that they are only permitted to perform specific tasks as per their assigned policies. Transaction validator 314 enforces the policies retrieved by chained transaction parser 312, ensuring that agents 102 an only access data or perform actions that are explicitly allowed by their policies. Chained transaction parser 312 explicitly avoids blanket authorizations, instead making dynamic authorization decisions at the transaction level to minimize security risks. In some embodiments, transaction validator 314 determines real-time risk scores that rate the risk for a transaction. By assigning real-time risk scores to transactions, the system provides an additional layer of security, enabling dynamic responses to high-risk activities. Transaction validator 314 approves or rejects each transaction based on the authorization decision, ensuring that only authorized transactions are allowed to proceed. In some examples, a booking agent in a holiday website has a static policy to give a 10% discount for a group with more than 3 people. If a chatbot agent that interacts with end customer is communicating with the booking agent to process a booking request with a discount set to 20%. This would be overriding the static policy, and hence the booking agent can treat it as a high risk transaction. It can then contact other agents (e.g., a sales/administrative agent) that can have policies set—for example, the administrative agent can have special policies added for campaigns, to allow higher discounts. Or perhaps there are policies to give higher discounts during non-season bookings, and so on. The booking agent would be able to learn from these override policies over a period of time, and then augment their static policies with these special considerations, so that subsequent transactions of similar types are categorized as lower risks.

By separating the parsing and validation logic into two distinct components, transaction validation system 108 ensures that chained transaction parser 312 focuses on analyzing the transaction chain and extracting relevant information. Then, transaction validator 314 focuses on making validation decisions and enforcing policies. This modular approach allows for greater flexibility, scalability, and maintainability of the system, while also ensuring that security risks are minimized through dynamic authorization decisions.

To tackle the complexity of multi-hop transactions, agents 102 incorporate metadata into each inter-agent communication, providing a comprehensive record of the transaction's history and context in chained metadata. This chained metadata includes the identity of the originating agent, a complete transaction chain history represented as a stack (e.g., BA1→AX2), and policy compliance flags for each hop in the chain. The flags may indicate policies that were verified in the previous transaction. When an agent 102 receives a transaction request, it extracts and analyzes the chained metadata stack to gain a thorough understanding of the transaction's origin and path. Agent 102 then validates the transaction against policies applicable to all agents 102 in the chain, ensuring that every hop in the transaction and the chain of hops comply with relevant policies. If any policy violation is detected during this validation process, the transaction is immediately denied, preventing potential security breaches or non-compliant activity from occurring. By embedding chained metadata into inter-agent communications and performing validation checks at each hop, the system ensures the integrity and trustworthiness of multi-hop transactions.

Transaction validator 314 provides real-time validation of transactions to ensure secure and compliant interactions between agents 102. Transaction validator 314 evaluates each transaction independently, considering factors such as transaction type, initiating agent, and target agent, to provide transaction-level granularity. Additionally, transaction validator 314 enforces policies dynamically in real-time, taking into account both the current transaction and the historical context of the prior agent's activities. Also, agent authentication system 106 also includes a robust rogue agent detection mechanism, which immediately denies any transactions initiated by unauthorized or unknown agents, providing an additional layer of security and protection against potential threats. By combining these key features, agent authentication system 106 and transaction validation system 108 provide a robust and adaptive security framework that ensures the integrity and trustworthiness of all transactions within the system.

### Transaction Processing Method

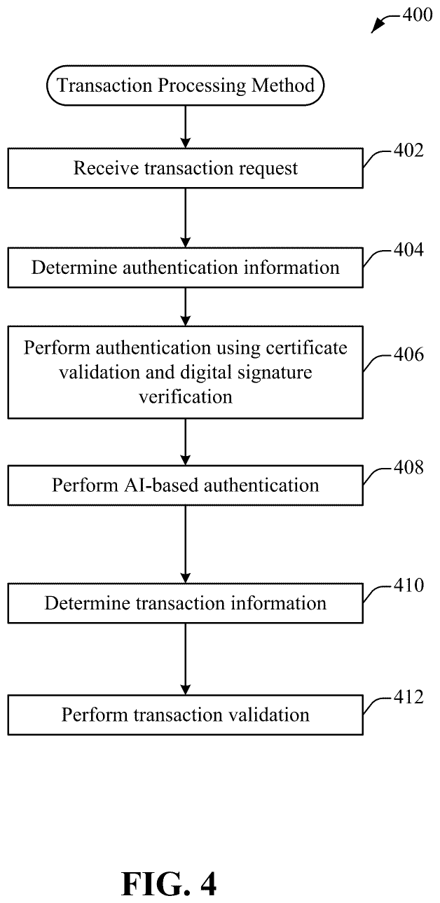

FIG. 4 depicts a flowchart 400 of a method for processing transactions according to some embodiments. At 402, an agent 102 receives a transaction request. In some examples, Agent A is requesting to transfer $1000.00 from its account to a customer's account via Agent X, which is a payment processing agent. The transaction request includes the necessary details such as the amount, currency, transaction ID, and timestamp.

This transaction request would then be processed through the system, where it would undergo authentication, authorization, and validation checks to ensure that it is legitimate and compliant with regulatory requirements. If the transaction is approved, it would be executed and the payment would be transferred to the customer's account. The process begins with the receipt of a transaction request from an agent A at an agent X. The transaction may also have been originated at an Agent B, which sends the transaction to Agent A.

At 404, agent 102 determines authentication Information. Agent 102 determines the authentication information required to verify the identity of the requesting agent. For example, information for public key cryptography, such as certificates and digital signatures are determined.

At 406, agent 102 performs identity authentication, such as via certificate validation and digital signature verification. The system performs certificate validation and digital signature verification to ensure that the requesting agent has a valid certificate and that the transaction request has not been tampered with.

At 408, agent 102 applies AI-Driven background identity verification. The system applies AI-driven background identity verification to analyze the historical behavior and patterns of the requesting agent, ensuring that it is legitimate and trustworthy. For example, a model may be trained to recognize the behavior of an agent. When the behavior deviates from the recognized behavior, the model may be able to recognize the difference and deny the transaction or output an alert.

If the authentication fails, then agent 102 may deny the transaction. The next steps of transaction validation may not be performed. If the authentication is successful, then transaction validation may be performed.

At 410, agent 102 determines transaction information. Agent 102 determines the specific details of the transaction request, including the type of transaction, the target agent, and any relevant data or parameters. Chained metadata from multiple hops may also be determined.

At 412, agent 102 performs transaction validation. Agent 102 performs validation of the transaction request against applicable policies and rules, ensuring that it complies with policies defined for multiple hop transactions between three of more agents.

An example of transaction information may be a transaction ID, agent IDs, transaction type, and a metadata stack. The transaction ID is a unique identifier for the transaction, such as a UUID or a hash value. The agent IDs are the IDs of the agents involved in the transaction, such as the originating agent, the target agent, and any intermediate agents. The transaction type is the type of transaction being performed, such as a payment transfer, a data query, or a workflow execution. The metadata stack is a stack of metadata that represents the chain of transactions, including information about each hop in the chain. An example of what the chained metadata might look like:
Transaction ID: TXN123456789
Agent IDs:
Originating Agent: AGENT_A
Target Agent: AGENT_X
Intermediate Agents: AGENT_B, AGENT_C
Transaction Type: Payment Transfer
Metadata Stack:
Hop 1: {Agent_A->Agent_B, Transaction_ID: TXN123456789, Type: AB1, Timestamp: 2023 Feb. 20 14:30:00}
Hop 2: {Agent_B->Agent_C, Transaction_ID: TXN123456789, Type: BC1, Timestamp: 2023 Feb. 20 14:31:00}
Hop 3: {Agent_C->Agent_X, Transaction_ID: TXN123456789, Type, CX1, Timestamp: 2023 Feb. 20 14:32:00}

In this example, the metadata stack represents the chain of transactions, with each hop in the chain including information about the agents involved, the transaction ID, a transaction type, and the timestamp. Agent 102 may validate the transaction information and that each agent in the chained metadata is authorized to perform the transaction. In some examples, there is a global transaction ID and type for the originating agent, and also for each of the intermediate hops, there are sub-types too (e.g., BA1->AX1). The chain of transactions will be used for validating per AI models. For example, the AI models analyze the behavior that AX1 transaction type is allowed from agent A to agent X if it is coming directly, but if it is coming in a chained transaction originating from agent B, then this would be disallowed. The rogue agents would be detected not only based on individual transactions, but also based on the certificate based validation and AI based behavioral validation.

### Chained Metadata

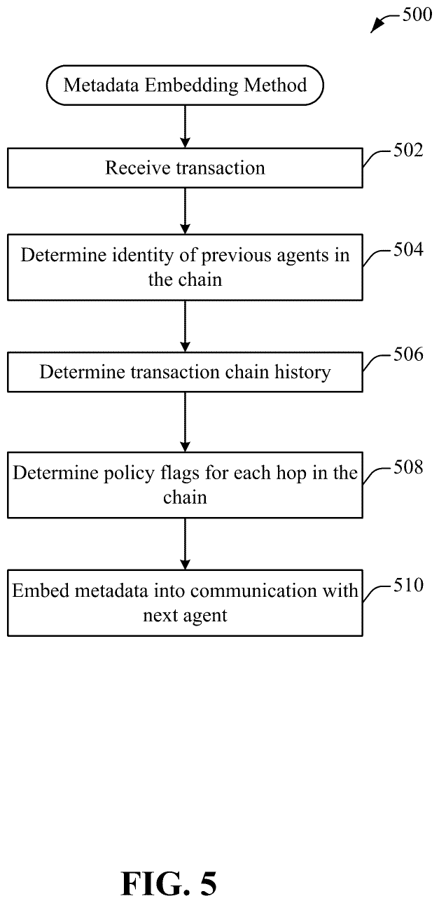

FIG. 5 depicts a flowchart 500 for generating chained metadata according to some embodiments. Chained metadata is generated when multiple agents process a transaction. At 502, agent 102 receives a transaction request. As discussed above, agent 102 checks if the transaction request is valid and if it contains all the necessary information. For example, agent 102 may check if the transaction request is authenticated and the transaction is validated. If the transaction request is invalid, agent 102 will reject it and return an error message. In an example of a transaction, Agent A may receive a transaction from Agent B.

At 504, agent 102 determines an identity of previous agents in the chain. Agent 102 identifies the agents that have previously participated in the transaction chain. In some embodiments, agent 102 checks the metadata stack to determine the IDs of the agents that have handled the transaction so far. For instance, if the transaction involves a payment transfer, the system may check the metadata stack to identify the agent that initiated the payment request and any intermediate agents that have processed the request. By determining the identities of previous agents in the chain, agent 102 can ensure that the transaction is legitimate across multiple hops. This type of validation is significantly more than point to point validation.

At 506, agent 102 determines a transaction chain history. Agent 102 may analyze the metadata stack to determine the complete history of the transaction chain. Agent 102 uses the metadata stack to identify all the agents that have participated in the transaction, including any intermediate agents and the source agent. For example, if the transaction involves a data query, agent 102 may analyze the metadata stack to determine which agents have accessed the data and what queries they have executed.

At 508, agent 102 determines policy flags for each hop in the chain. Agent 102 checks the policy flags associated with each hop in the transaction chain to determine if any policy flags have been set for each agent that has participated in the transaction. For instance, if an agent has a policy flag indicating that it is not allowed to access sensitive data, agent 102 will prevent it from accessing such data even if it is part of the transaction chain. By determining the policy flags for each hop in the chain, the system can ensure that the transaction is executed in accordance with organizational policies and regulatory requirements.

At 510, agent 102 embeds metadata into the communication with the next agent. Agent 102 adds the metadata stack to the transaction request, including any updates or modifications made during the previous steps. For example, if an agent 102 has updated the transaction request, agent 102 embed the updated metadata stack into the communication with the next agent. By embedding the metadata into the communication, the system can ensure that all agents involved in the transaction have access to the complete history of the transaction chain and can validate the entire transaction chain accordingly.

### Transaction Validation

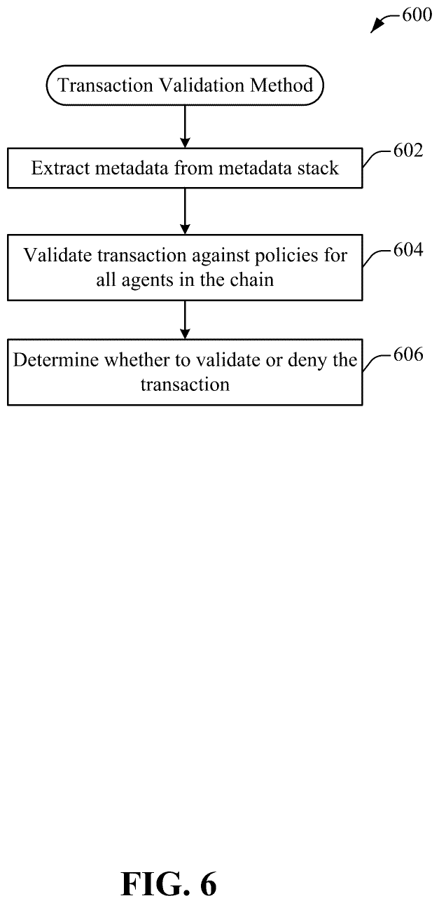

FIG. 6 depicts a flowchart 600 of a method for validating a transaction according to some embodiments. At 602, agent 102 receives a transaction request from another agent and extracts metadata from the metadata stack. As discussed above, agent 102 checks if the transaction request is valid and if it contains all the necessary information, such as the agent's id and the type of transaction. For example, if the transaction involves a payment transfer, agent 102 may check if the transaction request includes the payer's account number and the payee's account number. by verifying the transaction request, agent 102 can ensure that it is legitimate and that it has not been tampered with.

At 604, agent 102 validates the transaction against policies for all agents in the chain. For example, instead of just validating the current point to point transaction, agent 102 validates the entire chain of hops in the transaction.

At 606, agent 102 determines whether to validate or deny the transaction. Agent 102 then validates the transaction or denies the transaction. In some examples, agents 102 receive a transaction request and add their its own metadata to the existing metadata. Usually, this metadata includes information such as the agent's id, timestamp, and transaction type. Initially, Agent A initiates a transaction that involves Agent B, and then Agent B initiates a transaction with Agent X. In the process, each agent adds its own metadata to the transaction request before passing it on to the next agent. This creates a chain of metadata that can be validated at Agent X.

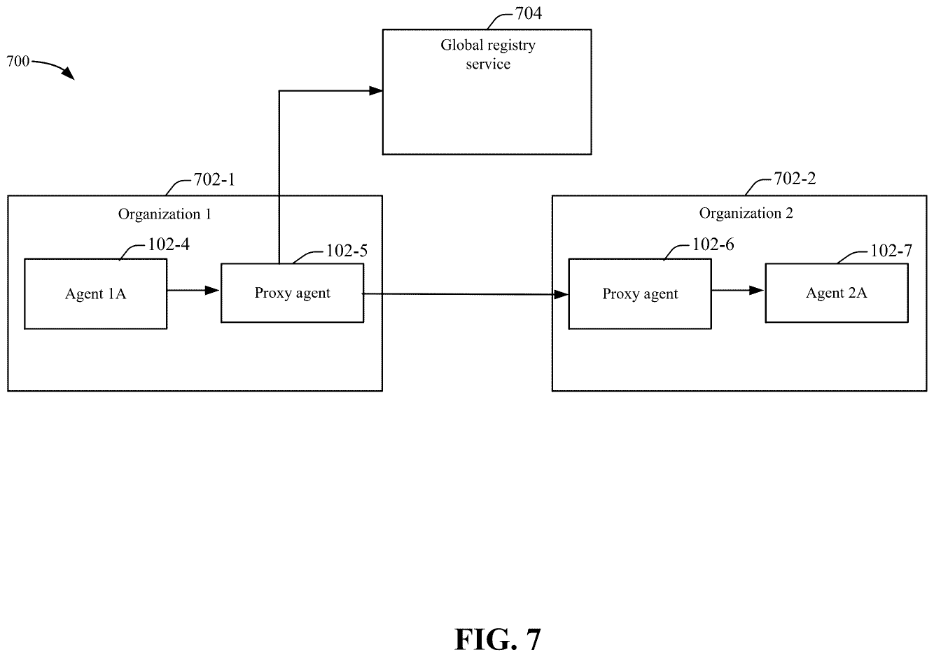

FIG. 7 depicts an example 700 of an agent directory and routing service that provides a framework for managing inter-agent interactions according to some embodiments. Organizations operate registry and proxy agents for managing inter-agent transactions. The registry agents and proxy agents work together to facilitate transactions between internal and external agents. A global agent registry service 704 forms the top level in the hierarchy, and serves as a directory service for routing the agent transactions to appropriate organization specific proxy services. The global agent registry service 704 provides a centralized directory for routing these transactions. This allows organizations to maintain control over their inter-organization transactions while still enabling secure and efficient communication with external agents. Additionally, the use of AI-driven summarization and abstraction techniques enables the system to adapt to changing transaction patterns and optimize routing accordingly.

The global agent registry service 704 provides secure tunneling of detailed transaction data that ensures this information remains private and protected from unauthorized access. This is particularly important in organizations where sensitive information is being exchanged between agents, as it helps to prevent data breaches and maintain the integrity of transactions. By combining these security features with efficient routing and directory services, the global agent registry service 704 provides a comprehensive solution for managing inter-agent transactions.

In some examples, an end customer interacts with an agent 1A 102-4 in organization 1 702-1 for a specific task. Transaction specific context built-up during the transaction. At some point, the agent 1A 102-4 realizes that it would need to accomplish some particular task to complete the transaction, which is not within the purview of its roles and responsibilities. Agent 1A 102-4 summarizes the request information, abstracting/masking out the context details, and the condensed request is sent to the proxy agent 102-5 of organization 1 702-1. Proxy agent 102-5 of organization 1 702-1 consults the global agent registry service 702 to identify the organization to which a chained/sub-transaction has to be initiated for accomplishing this specific task. In this case, it is going to be the proxy agent 102-6 of organization 2 702-2. Once an organization specific proxy agent is identified in the above step, then the proxy agent 102-5 of organization 1 initiates a transaction to the proxy agent 102-6 of organization 2 702-2. The transaction can include the condensed summary information, along with the detailed transaction details and context information embedded in encrypted form, which would get tunneled to the final destination agent (agent 2A 102-7) within the destination organization 2 702-2. So, the proxy agent 102-5 would only take care of authentication and routing based on the condensed summary information, and the transaction specific authorization would be done by the final destination agent 102-6 after decryption of the embedded data.

### Conclusion

The system provides a robust framework for securing inter-agent communications and transactions. By combining advanced authentication mechanisms, granular policy-based authorization, hierarchical agent transaction routing and metadata-driven transaction analysis, it ensures a high level of security while maintaining operational efficiency.

In various implementations, the models and/or modules described herein may be classification, predictive, generative, conversational, or another form of artificial intelligence (AI) technology, such as AI model(s), agents, etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware-or software-based framework that performs one or more functions, such as retrieving, generating, accessing, transmitting, etc. The AI technology may be implemented by a computer including a processor or a central processing unit (CPU) coupled to one or more storage system(s), non-transitory machine readable medium(s), memory, or other machine readable storage medium(s).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, a plurality of input prompts may be provided to the AI technology for the purpose of eliciting particular responses. In various implementations, the plurality of input prompts may correspond to the particular field or task to which the AI technology is trained. Additionally, the AI technology may be implemented along with a plurality of additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

FIG. 7 shows a block diagram of an example of an environment 710 that includes an on-demand database service configured in accordance with some implementations. Environment 710 may include user systems 712, network 714, database system 716, processor system 717, application platform 718, network interface 720, tenant data storage 722, tenant data 723, system data storage 724, system data 725, program code 726, process space 728, User Interface (UI) 730, Application Program Interface (API) 732, PL/SOQL 734, save routines 736, application setup mechanism 738, application servers 750-1 through 750-N, system process space 752, tenant process spaces 754, tenant management process space 760, tenant storage space 762, user storage 764, and application metadata 766. Some of such devices may be implemented using hardware or a combination of hardware and software and may be implemented on the same physical device or on different devices. Thus, terms such as “data processing apparatus,” “machine,” “server” and “device” as used herein are not limited to a single hardware device, but rather include any hardware and software configured to provide the described functionality.

An on-demand database service, implemented using system 716, may be managed by a database service provider. Some services may store information from one or more tenants into tables of a common database image to form a multi-tenant database system (MTS). As used herein, each MTS could include one or more logically and/or physically connected servers distributed locally or across one or more geographic locations. Databases described herein may be implemented as single databases, distributed databases, collections of distributed databases, or any other suitable database system. A database image may include one or more database objects. A relational database management system (RDBMS) or a similar system may execute storage and retrieval of information against these objects.

In some implementations, the application platform 718 may be a framework that allows the creation, management, and execution of applications in system 716. Such applications may be developed by the database service provider or by users or third-party application developers accessing the service. Application platform 718 includes an application setup mechanism 738 that supports application developers' creation and management of applications, which may be saved as metadata into tenant data storage 722 by save routines 736 for execution by subscribers as one or more tenant process spaces 754 managed by tenant management process 760 for example. Invocations to such applications may be coded using PL/SOQL 734 that provides a programming language style interface extension to API 732. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes. Such system processes may manage retrieval of application metadata 766 for a subscriber making such an invocation. Such system processes may also manage execution of application metadata 766 as an application in a virtual machine.

In some implementations, each application server 750 may handle requests for any user associated with any organization. A load balancing function (e.g., an F5 Big-IP load balancer) may distribute requests to the application servers 750 based on an algorithm such as least-connections, round robin, observed response time, etc. Each application server 750 may be configured to communicate with tenant data storage 722 and the tenant data 723 therein, and system data storage 724 and the system data 725 therein to serve requests of user systems 712. The tenant data 723 may be divided into individual tenant storage spaces 762, which can be either a physical arrangement and/or a logical arrangement of data. Within each tenant storage space 762, user storage 764 and application metadata 766 may be similarly allocated for each user. For example, a copy of a user's most recently used (MRU) items might be stored to user storage 764. Similarly, a copy of MRU items for an entire tenant organization may be stored to tenant storage space 762. A UI 730 provides a user interface and an API 732 provides an application programming interface to system 716 resident processes to users and/or developers at user systems 712.

System 716 may implement a web-based network security system. For example, in some implementations, system 716 may include application servers configured to implement and execute network security software applications. The application servers may be configured to provide related data, code, forms, web pages and other information to and from user systems 712. Additionally, the application servers may be configured to store information to, and retrieve information from a database system. Such information may include related data, objects, and/or Webpage content. With a multi-tenant system, data for multiple tenants may be stored in the same physical database object in tenant data storage 722, however, tenant data may be arranged in the storage medium(s) of tenant data storage 722 so that data of one tenant is kept logically separate from that of other tenants. In such a scheme, one tenant may not access another tenant's data, unless such data is expressly shared.

Several elements in the system shown in FIG. 7 include conventional, well-known elements that are explained only briefly here. For example, user system 712 may include processor system 712A, memory system 712B, input system 712C, and output system 712D. A user system 712 may be implemented as any computing device(s) or other data processing apparatus such as a mobile phone, laptop computer, tablet, desktop computer, or network of computing devices. User system 12 may run an internet browser allowing a user (e.g., a subscriber of an MTS) of user system 712 to access, process and view information, pages and applications available from system 716 over network 714. Network 714 may be any network or combination of networks of devices that communicate with one another, such as any one or any combination of a LAN (local area network), WAN (wide area network), wireless network, or other appropriate configuration.

The users of user systems 712 may differ in their respective capacities, and the capacity of a particular user system 712 to access information may be determined at least in part by “permissions” of the particular user system 712. As discussed herein, permissions generally govern access to computing resources such as data objects, components, and other entities of a computing system, such as a network security system, a social networking system, and/or a CRM database system. “Permission sets” generally refer to groups of permissions that may be assigned to users of such a computing environment. For instance, the assignments of users and permission sets may be stored in one or more databases of System 716. Thus, users may receive permission to access certain resources. A permission server in an on-demand database service environment can store criteria data regarding the types of users and permission sets to assign to each other. For example, a computing device can provide to the server data indicating an attribute of a user (e.g., geographic location, industry, role, level of experience, etc.) and particular permissions to be assigned to the users fitting the attributes. Permission sets meeting the criteria may be selected and assigned to the users. Moreover, permissions may appear in multiple permission sets. In this way, the users can gain access to the components of a system.

In some an on-demand database service environments, an Application Programming Interface (API) may be configured to expose a collection of permissions and their assignments to users through appropriate network-based services and architectures, for instance, using Simple Object Access Protocol (SOAP) Web Service and Representational State Transfer (REST) APIs.

In some implementations, a permission set may be presented to an administrator as a container of permissions. However, each permission in such a permission set may reside in a separate API object exposed in a shared API that has a child-parent relationship with the same permission set object. This allows a given permission set to scale to millions of permissions for a user while allowing a developer to take advantage of joins across the API objects to query, insert, update, and delete any permission across the millions of possible choices. This makes the API highly scalable, reliable, and efficient for developers to use.

In some implementations, a permission set API constructed using the techniques disclosed herein can provide scalable, reliable, and efficient mechanisms for a developer to create tools that manage a user's permissions across various sets of access controls and across types of users. Administrators who use this tooling can effectively reduce their time managing a user's rights, integrate with external systems, and report on rights for auditing and troubleshooting purposes. By way of example, different users may have different capabilities with regard to accessing and modifying application and database information, depending on a user's security or permission level, also called authorization. In systems with a hierarchical role model, users at one permission level may have access to applications, data, and database information accessible by a lower permission level user, but may not have access to certain applications, database information, and data accessible by a user at a higher permission level.

As discussed above, system 716 may provide on-demand database service to user systems 712 using an MTS arrangement. By way of example, one tenant organization may be a company that employs a sales force where each salesperson uses system 716 to manage their sales process. Thus, a user in such an organization may maintain contact data, leads data, customer follow-up data, performance data, goals and progress data, etc., all applicable to that user's personal sales process (e.g., in tenant data storage 722). In this arrangement, a user may manage his or her sales efforts and cycles from a variety of devices, since relevant data and applications to interact with (e.g., access, view, modify, report, transmit, calculate, etc.) such data may be maintained and accessed by any user system 712 having network access.

When implemented in an MTS arrangement, system 716 may separate and share data between users and at the organization-level in a variety of manners. For example, for certain types of data each user's data might be separate from other users' data regardless of the organization employing such users. Other data may be organization-wide data, which is shared or accessible by several users or potentially all users form a given tenant organization. Thus, some data structures managed by system 716 may be allocated at the tenant level while other data structures might be managed at the user level. Because an MTS might support multiple tenants including possible competitors, the MTS may have security protocols that keep data, applications, and application use separate. In addition to user-specific data and tenant-specific data, system 716 may also maintain system-level data usable by multiple tenants or other data. Such system-level data may include industry reports, news, postings, and the like that are sharable between tenant organizations.

In some implementations, user systems 712 may be client systems communicating with application servers 750 to request and update system-level and tenant-level data from system 716. By way of example, user systems 712 may send one or more queries requesting data of a database maintained in tenant data storage 722 and/or system data storage 724. An application server 750 of system 716 may automatically generate one or more SQL statements (e.g., one or more SQL queries) that are designed to access the requested data. System data storage 724 may generate query plans to access the requested data from the database.

The database systems described herein may be used for a variety of database applications. By way of example, each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some implementations, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in an MTS. In certain implementations, for example, all custom entity data rows may be stored in a single multi-tenant physical table, which may contain multiple logical tables per organization. It may be transparent to customers that their multiple “tables” are in fact stored in one large table or that their data may be stored in the same table as the data of other customers.

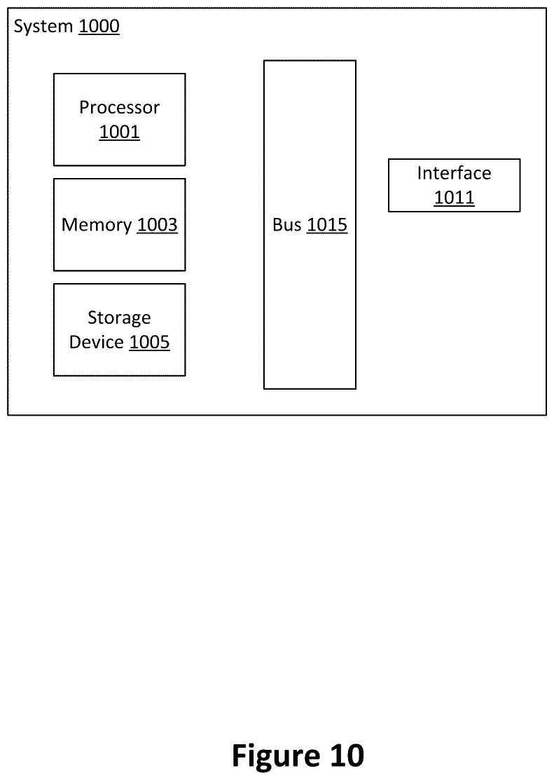

FIG. 9A shows a system diagram of an example of architectural components of an on-demand database service environment 900, configured in accordance with some implementations. A client machine located in the cloud 904 may communicate with the on-demand database service environment via one or more edge routers 908 and 912. A client machine may include any of the examples of user systems 712 described above. The edge routers 908 and 912 may communicate with one or more core switches 920 and 924 via firewall 916. The core switches may communicate with a load balancer 928, which may distribute server load over different pods, such as the pods 940 and 944 by communication via pod switches 932 and 936. The pods 940 and 944, which may each include one or more servers and/or other computing resources, may perform data processing and other operations used to provide on-demand services. Components of the environment may communicate with a database storage 956 via a database firewall 948 and a database switch 952.

Accessing an on-demand database service environment may involve communications transmitted among a variety of different components. The environment 900 is a simplified representation of an actual on-demand database service environment. For example, some implementations of an on-demand database service environment may include anywhere from one to many devices of each type. Additionally, an on-demand database service environment need not include each device shown, or may include additional devices not shown, in FIGS. 9A and 9B.

The cloud 904 refers to any suitable data network or combination of data networks, which may include the Internet. Client machines located in the cloud 904 may communicate with the on-demand database service environment 900 to access services provided by the on-demand database service environment 900. By way of example, client machines may access the on-demand database service environment 900 to retrieve, store, edit, and/or process network security information.

In some implementations, the edge routers 908 and 912 route packets between the cloud 904 and other components of the on-demand database service environment 900. The edge routers 908 and 912 may employ the Border Gateway Protocol (BGP). The edge routers 908 and 912 may maintain a table of IP networks or ‘prefixes’, which designate network reachability among autonomous systems on the internet.

In one or more implementations, the firewall 916 may protect the inner components of the environment 900 from internet traffic. The firewall 916 may block, permit, or deny access to the inner components of the on-demand database service environment 900 based upon a set of rules and/or other criteria. The firewall 916 may act as one or more of a packet filter, an application gateway, a stateful filter, a proxy server, or any other type of firewall.

In some implementations, the core switches 920 and 924 may be high-capacity switches that transfer packets within the environment 900. The core switches 920 and 924 may be configured as network bridges that quickly route data between different components within the on-demand database service environment. The use of two or more core switches 920 and 924 may provide redundancy and/or reduced latency.

In some implementations, communication between the pods 940 and 944 may be conducted via the pod switches 932 and 936. The pod switches 932 and 936 may facilitate communication between the pods 940 and 944 and client machines, for example via core switches 920 and 924. Also or alternatively, the pod switches 932 and 936 may facilitate communication between the pods 940 and 944 and the database storage 956. The load balancer 928 may distribute workload between the pods, which may assist in improving the use of resources, increasing throughput, reducing response times, and/or reducing overhead. The load balancer 928 may include multilayer switches to analyze and forward traffic.

In some implementations, access to the database storage 956 may be guarded by a database firewall 948, which may act as a computer application firewall operating at the database application layer of a protocol stack. The database firewall 948 may protect the database storage 956 from application attacks such as structure query language (SQL) injection, database rootkits, and unauthorized information disclosure. The database firewall 948 may include a host using one or more forms of reverse proxy services to proxy traffic before passing it to a gateway router and/or may inspect the contents of database traffic and block certain content or database requests. The database firewall 948 may work on the SQL application level atop the TCP/IP stack, managing applications' connection to the database or SQL management interfaces as well as intercepting and enforcing packets traveling to or from a database network or application interface.

In some implementations, the database storage 956 may be an on-demand database system shared by many different organizations. The on-demand database service may employ a single-tenant approach, a multi-tenant approach, a virtualized approach, or any other type of database approach. Communication with the database storage 956 may be conducted via the database switch 952. The database storage 956 may include various software components for handling database queries. Accordingly, the database switch 952 may direct database queries transmitted by other components of the environment (e.g., the pods 940 and 944) to the correct components within the database storage 956.

FIG. 9B shows a system diagram further illustrating an example of architectural components of an on-demand database service environment, in accordance with some implementations. The pod 944 may be used to render services to user(s) of the on-demand database service environment 900. The pod 944 may include one or more content batch servers 964, content search servers 968, query servers 982, file servers 986, access control system (ACS) servers 980, batch servers 984, and app servers 988. Also, the pod 944 may include database instances 990, quick file systems (QFS) 992, and indexers 994. Some or all communication between the servers in the pod 944 may be transmitted via the switch 936.

In some implementations, the app servers 988 may include a framework dedicated to the execution of procedures (e.g., programs, routines, scripts) for supporting the construction of applications provided by the on-demand database service environment 900 via the pod 944. One or more instances of the app server 988 may be configured to execute all or a portion of the operations of the services described herein.

In some implementations, as discussed above, the pod 944 may include one or more database instances 990. A database instance 990 may be configured as an MTS in which different organizations share access to the same database, using the techniques described above. Database information may be transmitted to the indexer 994, which may provide an index of information available in the database 990 to file servers 986. The QFS 992 or other suitable filesystem may serve as a rapid-access file system for storing and accessing information available within the pod 944. The QFS 992 may support volume management capabilities, allowing many disks to be grouped together into a file system. The QFS 992 may communicate with the database instances 990, content search servers 968 and/or indexers 994 to identify, retrieve, move, and/or update data stored in the network file systems (NFS) 996 and/or other storage systems.

In some implementations, one or more query servers 982 may communicate with the NFS 996 to retrieve and/or update information stored outside of the pod 944. The NFS 996 may allow servers located in the pod 944 to access information over a network in a manner similar to how local storage is accessed. Queries from the query servers 922 may be transmitted to the NFS 996 via the load balancer 928, which may distribute resource requests over various resources available in the on-demand database service environment 900. The NFS 996 may also communicate with the QFS 992 to update the information stored on the NFS 996 and/or to provide information to the QFS 992 for use by servers located within the pod 944.

In some implementations, the content batch servers 964 may handle requests internal to the pod 944. These requests may be long-running and/or not tied to a particular customer, such as requests related to log mining, cleanup work, and maintenance tasks. The content search servers 968 may provide query and indexer functions such as functions allowing users to search through content stored in the on-demand database service environment 900. The file servers 986 may manage requests for information stored in the file storage 998, which may store information such as documents, images, basic large objects (BLOBs), etc. The query servers 982 may be used to retrieve information from one or more file systems. For example, the query system 982 may receive requests for information from the app servers 988 and then transmit information queries to the NFS 996 located outside the pod 944. The ACS servers 980 may control access to data, hardware resources, or software resources called upon to render services provided by the pod 944. The batch servers 984 may process batch jobs, which are used to run tasks at specified times. Thus, the batch servers 984 may transmit instructions to other servers, such as the app servers 988, to trigger the batch jobs.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of present disclosure.

FIG. 10 illustrates one example of a computing device. According to various embodiments, a system 1000 suitable for implementing embodiments described herein includes a processor 1001, a memory module 1003, a storage device 1005, an interface 1011, and a bus 1015 (e.g., a PCI bus or other interconnection fabric.) System 1000 may operate as variety of devices such as an application server, a database server, or any other device or service described herein. Although a particular configuration is described, a variety of alternative configurations are possible. The processor 1001 may perform operations such as those described herein. Instructions for performing such operations may be embodied in the memory 1003, on one or more non-transitory computer readable media, or on some other storage device. Various specially configured devices can also be used in place of or in addition to the processor 1001. The interface 1011 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Apex, Java, Python, C++, C, HTML, any other markup language, JavaScript, ActiveX, VBScript, or Perl. Examples of computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various implementations have been described herein, it should be understood that they have been presented by way of example only, and not limitation. For example, some techniques and mechanisms are described herein in the context of on-demand computing environments that include MTSs. However, the techniques of disclosed herein apply to a wide variety of computing environments. Particular embodiments may be implemented without some or all of the specific details described herein. In other instances, well known process operations have not been described in detail in order to avoid unnecessarily obscuring the disclosed techniques. Accordingly, the breadth and scope of the present application should not be limited by any of the implementations described herein, but should be defined only in accordance with the claims and their equivalents.

FIG. 9 illustrates one example of a computing device. According to various embodiments, a system 900 suitable for implementing embodiments described herein includes a processor 901, a memory module 903, a storage device 905, an interface 911, and a bus 915 (e.g., a PCI bus or other interconnection fabric.) System 900 may operate as variety of devices such as an application server, a database server, or any other device or service described herein. Although a particular configuration is described, a variety of alternative configurations are possible. The processor 901 may perform operations such as those described herein. Instructions for performing such operations may be embodied in the memory 903, on one or more non-transitory computer readable media, or on some other storage device. Various specially configured devices can also be used in place of or in addition to the processor 901. The interface 911 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Apex, Java, Python, C++, C, HTML, any other markup language, JavaScript, ActiveX, VBScript, or Perl. Examples of computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various implementations have been described herein, it should be understood that they have been presented by way of example only, and not limitation. For example, some techniques and mechanisms are described herein in the context of on-demand computing environments that include MTSs. However, the techniques of disclosed herein apply to a wide variety of computing environments. Particular embodiments may be implemented without some or all of the specific details described herein. In other instances, well known process operations have not been described in detail in order to avoid unnecessarily obscuring the disclosed techniques. Accordingly, the breadth and scope of the present application should not be limited by any of the implementations described herein, but should be defined only in accordance with the claims and their equivalents.

1. A method comprising:
receiving, at a first agent, a request for a transaction, wherein the request is from a second agent, wherein the first agent and the second agent comprise artificial intelligence (AI) agents;
authenticating the second agent using an authentication policy to determine an authentication result, wherein the authentication policy is based on authenticating an identity of the second agent;
determining chained transaction metadata based on a chain of multiple transactions including the second agent and a third agent and the transaction;
validating the transaction using the chained transaction metadata based on a transaction policy to determine a transaction validation result, wherein the transaction validation result determines whether the first agent can perform the chain of multiple transactions; and
determining whether to validate the transaction based on the authentication result and the transaction validation result.

2. The method of claim 1, wherein:
a first request for the transaction is sent to the second agent from the third agent, and
the request for the transaction is a second request sent by the second agent to the first agent.

3. The method of claim 2, wherein:
the first request is a first type of request, and
the second request is a second type of request.

4. The method of claim 3, wherein:
the second type of request is validated at the second agent, and
the first type of request is not validated at the first agent.

5. The method of claim 3, wherein:
the second type of request is validated at the second agent, and
a chain of the first type of request and the second type of request is not validated at the first agent.

6. The method of claim 1, wherein authenticating the second agent comprises:
authenticating the second agent using a first authentication process that authenticates first information for the second agent; and
authenticating the second agent using a second authentication process that authenticates second information for the second agent.

7. The method of claim 6, wherein:
the first authentication process authenticates cryptographic information for the identity of the second agent, and
the second authentication process authenticates behavior based information for the second agent using a model.

8. The method of claim 7, wherein the model is dynamically trained with updated training data to adjust to different behaviors.

9. The method of claim 1, wherein determining chained transaction metadata comprises:
reviewing a metadata stack in which the second agent and the third agent added metadata.

10. The method of claim 1, wherein:
the chained transaction metadata includes first metadata added by the third agent, and
the chained transaction metadata includes second metadata added by the second agent.

11. The method of claim 10, wherein validating the transaction based on the chained transaction metadata comprises:
validating a chain of the first metadata and the second metadata; and
validating the request for the transaction when the chain of the first metadata and the second metadata is validated.

12. The method of claim 1, wherein determining whether to validate the transaction based on the authentication result and the transaction validation result comprises:
not validating the transaction when the authentication result is not authenticated.

13. The method of claim 1, wherein determining whether to validate the transaction based on the authentication result and the transaction validation result comprises:
not validating the transaction when a chain of the multiple transactions is not validated.

14. The method of claim 1, wherein validating the transaction comprises:
categorizing the third agent or the second agent; and
validating the third agent or the second agent based on a category of the respective third agent or the second agent.

15. The method of claim 1, wherein the chained transaction metadata is based on multiple transactions including three or more agents.

16. The method of claim 1, wherein:
the chained transaction included communicating with a global registry to determine a second organization,
a first proxy agent of a first organization is used to communicate with a second proxy agent of the second organization,
the first proxy agent authenticates the second proxy agent, and
the second proxy agent validates the transaction.

17. A non-transitory computer-readable storage medium having stored thereon computer executable instructions, which when executed by a computing device, cause the computing device to be operable for:
receiving, at a first agent, a request for a transaction, wherein the request is from a second agent, wherein the first agent and the second agent comprise artificial intelligence (AI) agents;
authenticating the second agent using an authentication policy to determine an authentication result, wherein the authentication policy is based on authenticating an identity of the second agent;
determining chained transaction metadata based on a chain of multiple transactions including the second agent and a third agent and the transaction;
validating the transaction using the chained transaction metadata based on a transaction policy to determine a transaction validation result, wherein the transaction validation result determines whether the first agent can perform the chain of multiple transactions; and
determining whether to validate the transaction based on the authentication result and the transaction validation result.

18. The non-transitory computer-readable storage medium of claim 17, wherein:
a first request for the transaction is sent to the second agent from the third agent, and
the request for the transaction is a second request sent by the second agent to the first agent.

19. The non-transitory computer-readable storage medium of claim 18, wherein:
the first request is a first type of request, and
the second request is a second type of request.

20. An apparatus comprising:
one or more computer processors; and
a computer-readable storage medium comprising instructions for controlling the one or more computer processors to be operable for:
receiving, at a first agent, a request for a transaction, wherein the request is from a second agent, wherein the first agent and the second agent comprise artificial intelligence (AI) agents;
authenticating the second agent using an authentication policy to determine an authentication result, wherein the authentication policy is based on authenticating an identity of the second agent;
determining chained transaction metadata based on a chain of multiple transactions including the second agent and a third agent and the transaction;
validating the transaction using the chained transaction metadata based on a transaction policy to determine a transaction validation result, wherein the transaction validation result determines whether the first agent can perform the chain of multiple transactions; and
determining whether to validate the transaction based on the authentication result and the transaction validation result.
